(19) United States
(12) Patent Application Publication
(10) Pub. No.: US 2025/0105396 A1
(43) Pub. Date: Mar. 27, 2025

(54) BATTERY MODULE COOLING STRUCTURE

(71) Applicants: Hyundai Motor Company, Seoul (KR); Kia Corporation, Seoul (KR)

(72) Inventors: Hyunchang Kang, Hwaseong (KR); Jiwoong Jung, Hwaseong (KR); Junyoung Kang, Hwaseong (KR)

(21) Appl. No.: 18/889,115

(22) Filed: Sep. 18, 2024

(30) Foreign Application Priority Data
Sep. 21, 2023 (KR) 10-2023-0126514

(51) Int. Cl. H01M 10/656; B60L 50/64; H01M 10/42; H01M 10/48; H01M 10/613; H01M 10/625; H01M 10/647; H01M 50/211; H01M 50/242; H01M 50/503

(52) U.S. Cl. CPC H01M 10/656; B60L 50/64; H01M 10/425; H01M 10/482; H01M 10/613; H01M 10/625; H01M 10/647; H01M 50/211; H01M 50/242; H01M 50/503; H01M 2220/20

(57) ABSTRACT

Provided is a battery module cooling structure, in which a battery module is configured by assembling a plurality of battery cells, the structure comprising: a battery module housing storing the battery module; and a sensing board assembly fastened to an end of an end plate disposed on an outermost side of the battery module, disposed to extend in a stacking direction of the plurality of battery cells, and having a flow opening for allowing a coolant to flow between the plurality of battery cells.

### CROSS-REFERENCE TO RELATED APPLICATION

This application claims under 35 U.S.C. §119(a) the benefit of Korean Patent Application No. 10-2023-0126514 filed in the Korean Intellectual Property Office on Sep. 21, 2023, the entire contents of which are incorporated herein by reference.

### BACKGROUND OF THE INVENTION

### Technical Field

The disclosure relates to a battery module cooling structure, and more particularly, to an immersion cooling battery module cooling structure that introduces a flow path, through which a coolant flows, to a battery sensing board or a bus bar.

### Background

In general, a battery pack for an eco-friendly vehicle may be manufactured by assembling a plurality of battery cells to form a battery module, and then assembling the plurality of battery modules to form a battery pack that is finally installed in the vehicle.

A pouch cell-type battery module may largely include the battery cell, a pressure pad, an end plate, a sensing board and the like. The battery module may require advanced battery cell cooling technology to match the improved performance of the battery and its higher specification for fast charging performance. Immersion cooling technology, which is a direct cooling method, may be considered to increase cooling performance of the battery. Components used in this immersion cooling method may include basic components of the battery module, a module housing, a cooling channel, and a coolant (or dielectric thermal fluid) for direct cooling.

Here, to cool an inner battery cell, the cooling channel may be disposed between the battery cells, thereby implementing the direct cooling through a coolant flow. However, a general battery cell module may have lower cooling efficiency because the presence of the sensing board on the inflow or outflow path of the coolant may interfere with the flow to the cooling channel between the battery cells.

### SUMMARY OF THE INVENTION

The disclosure attempts to provide a battery module cooling structure that may improve cooling performance efficiency by forming a flow opening that allows a coolant flow in a sensing board or a bus bar for an immersion cooling battery module.

According to an embodiment, provided is a structure for cooling a battery module, the structure including: a battery module housing storing the battery module, wherein the battery module is configured by assembling a plurality of battery cells; and a sensing board assembly fastened to an end plate disposed on an outermost side of the battery module, to the sensing board assembly extending in a stacking direction of the plurality of battery cells, and having a flow opening to allow coolant to flow between the plurality of battery cells.

The sensing board assembly may include a sensing board electrically connected to an electrode lead disposed on the battery cell and configured to detect a state of the battery cell, and a bus bar electrically connected to the sensing board and configured to connect a voltage line between the battery cells in the battery module or between the battery modules.

The bus bar may icnlude additional surface area with flow openings.

The bus bar may be overlapped and coupled with the sensing board, and the flow opening may include a first flow opening formed in a portion where the bus bar and the sensing board are overlapped and coupled with each other and simultaneously passing through the bus bar and the sensing board, and a second flow opening formed in a portion where the bus bar and the sensing board are neither overlapped nor coupled with each other and passing through the sensing board.

The first flow opening may include a plurality of circular openings formed in a length direction of the bus bar.

The first flow opening may be further formed in the portion where the bus bar and the sensing board are neither overlapped nor coupled with each other.

The second flow opening may include a plurality of square openings arranged in the stacking direction of the plurality of battery cells.

The plurality of square openings may be elongated in the length direction.

The plurality of square openings may correspond to channels between the plurality of battery cells.

The electrode lead may be in electrical connection with the sensing board by passing through the second flow opening to be folded and overlapped with the sensing board.

The electrode lead may be connected to the sensing board to be overlapped with the first flow opening, and have an opening overlapped with the first flow opening.

The sensing board assembly may be installed on each of two ends of the battery module housing.

A plurality of pressure pads may respectively be attached to outer surfaces of the battery cells.

Each of the plurality of pressure pads may be disposed between adjacent battery cells and is configured to absorb swelling of the battery cells.

Each of the plurality of pressure pads may be configured to fix the plurality of battery cells in position and relieve impact applied to the battery cells.

The battery module housing may include an inflow port for the coolant on one side and an outlet port for the coolant on the opposite side, the inflow port and the outlet port communicating with the inside of the battery module housing.

The positions of the inflow port and the outlet port may be asymmetric to ensure even coolant flow within the battery module housing.

The inflow port and the outlet port may be positioned vertically or laterally relative to each other.

The sensing board assembly may be fastened to an end of the end plate.

According to an embodiment of the disclosure, the flow opening, through which the coolant flows, may be formed in the sensing board or the bus bar in the immersion cooling battery module to thus allow the coolant to flow in, flow, and flow out through the optimal path between the battery cells, thereby maximizing the cooling performance efficiency.

In addition, the flow opening may be formed in the sensing board to thus increase the flow rate into the battery cell, thereby improving the cooling performance and reducing the temperature difference between the battery cells.

In addition, the flow opening may be formed in the bus bar to thus expand the surface area of the bus bar and increase the cooling effect in response to the large amount of heat occurring in the bus bar.

As discussed, the method and system suitably include use of a controller or processer.

### BRIEF DESCRIPTION OF THE DRAWINGS

FIG. 1 is an exploded perspective view showing a battery module cooling structure according to an embodiment of the disclosure.

FIG. 2 is a front view showing that a sensing board of the battery module cooling structure is connected to an electrode lead according to an embodiment of the disclosure.

FIG. 3 is a perspective view schematically showing an inflow state of a coolant in the battery module cooling structure according to an embodiment of the disclosure.

FIG. 4 is a front view showing that the sensing board and a bus bar are connected to the electrode lead in the battery module cooling structure according to an embodiment of the disclosure.

FIG. 5 is a partial perspective view showing that the sensing board and the bus bar are connected to the electrode lead in the battery module cooling structure according to an embodiment of the disclosure.

FIG. 6 is a perspective view showing that the sensing board and the bus bar are connected to each other in the battery module cooling structure according to an embodiment of the disclosure.

### DETAILED DESCRIPTION OF THE EMBODIMENTS

Hereinafter, embodiments of the disclosure will be described in detail with reference to the accompanying drawings so that those skilled in the art to which the disclosure pertains may easily practice the disclosure. The disclosure may be implemented in various different forms and is not limited to the embodiments described herein.

In addition, in several embodiments, components having the same configuration will be representatively described using the same reference numerals in an embodiment, and only components different from those of an embodiment will be described in the other embodiments.

It should be understood that the drawings are schematic and not drawn to scale. The size and proportion of a component in the drawings are shown relatively exaggerated or reduced in size in order to clearly and easily explain the drawings. This arbitrary size is only illustrative and not limitative. In addition, the same reference numeral is used to denote a similar feature of the same structure, element or part shown in two or more drawings. When it is described that an element is referred to as being “on” or “above” another element, it is to be understood that the element may be directly “on” another element or “above” another element having a third element interposed therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

An embodiment of the disclosure specifically represents one embodiment of the disclosure. As a result, diagrams may be various modified. Accordingly, an embodiment is not limited to a specific shape of the illustrated portion, and may include, for example, a shape modified when produced.

Hereinafter, a battery module cooling structure according to an embodiment of the disclosure is described in detail with reference to the accompanying drawings.

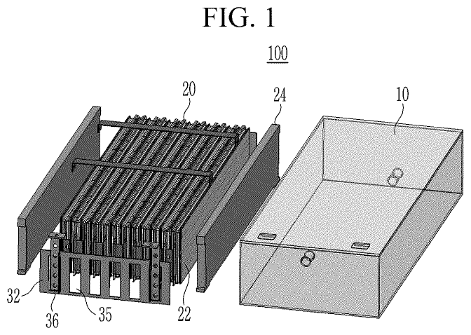

FIG. 1 is an exploded perspective view showing a battery module cooling structure according to an embodiment of the disclosure.

Referring to FIG. 1, a battery module cooling structure 100, according to an embodiment of the disclosure, may include a battery module housing 10 storing a battery module and a sensing board assembly fastened to an end of an end plate 24 disposed on the outermost side of the battery module.

An inflow port, through which coolant flows into the battery module housing 10, may be disposed on one side of the battery module housing 10, and an outlet port, through which the coolant flows out from the inside of the battery module housing 10 to the outside, may be disposed on the other side of the battery module housing 10, opposite to the inflow port.

The inflow port and the outlet port may communicate with the inside of the battery module housing 10. In addition, the positions of the inlet port and the outlet port may be asymmetric to ensure even coolant flow within the battery module housing 10. That is, based on FIG. 1, the inflow port may be positioned higher than the outlet port, and the outlet port may be positioned further to the right than the inflow port.

The sensing board assembly may be disposed to extend from the end of the end plate 24 in the stacking direction of a plurality of battery cells 20 and have flow openings 34 and 35 allowing the coolant to flow between the plurality of battery cells 20.

The sensing board assembly may include a sensing board 32 and a bus bar 36. The sensing board 32 may be electrically connected to an electrode lead 26 disposed on the battery cell 20 to detect a state of the battery cell 20, and the bus bar 36 may be electrically connected to the sensing board 32 and the electrode lead 26.

The sensing boards 32 may be installed at both ends of the battery module housing 10, that is, to oppose each other at the front and rear sides of the battery module housing 10 based on FIG. 1.

In addition, a plurality of pressure pads 22 may respectively be attached to outer surfaces of the battery cells 20. Each of the plurality of pressure pads 22 may be disposed between the plurality of battery cells 20 and serve to absorb swelling of the battery cell 20. In addition, the pressure pad 22 may fix each of the plurality of battery cells 20 and relieve an impact applied to the battery cell 20. The end plate 24 may be attached to the outside of the pressure pad 22 disposed on the outermost side of the battery module. The sensing board 32 may be fastened to the end of the end plate 24.

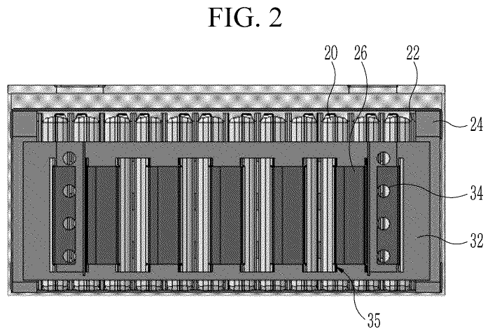

FIG. 2 is a front view showing that the sensing board of the battery module cooling structure is connected to the electrode lead according to an embodiment of the disclosure.

Referring to FIG. 2, the flow openings 34 and 35 may be formed in the sensing board 32. The flow openings 34 and 35 may include the first flow opening 34 including a plurality of circular openings each formed in a corresponding portion of the sensing board 32, to which the bus bar 36 is coupled, in a length direction of the bus bar 36, and the second flow opening 35 including a plurality of square openings arranged in the stacking direction of the plurality of battery cells 20.

The sensing board 32 may be coupled to each of two ends of the end plate 24, and the electrode lead 26 disposed on the battery cell 20 may pass through the second flow opening 35 to be folded on each of two sides of the second flow opening 35. The electrode lead 26 may include positive and negative electrodes and may be in electrical connection with the sensing board 32 by being folded on each of the two sides of the second flow opening 35 and in contact with the sensing board 32.

The first flow opening 34 may be formed in a portion where the bus bar 36 and the sensing board 32 overlapped and coupled with each other, and formed in the same portion where the sensing board 32, the bus bar 36, and the electrode lead 26 are overlapped with one another. The electrode lead 26 may include one positive electrode lead or one negative electrode lead in the portion where the first flow opening 34 is formed to thus be attached to the sensing board 32.

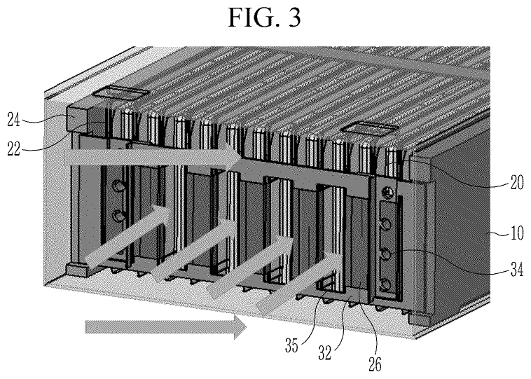

FIG. 3 is a perspective view schematically showing an inflow state of the coolant in the battery module cooling structure according to an embodiment of the disclosure.

Referring to FIG. 3, the coolant flowing into the battery module housing 10 through the inflow port may flow into the battery module through the sensing board assembly. The coolant may flow into the battery module through the first and second flow openings 34 and 35 formed in the sensing board 32, and the upper and lower sides of the sensing board 32.

The sensing board assembly may be installed at each of two ends of the battery module housing 10. The coolant flowing into the battery module may flow between the battery cells 20, cooling them, and then flow out from the battery module through the flow openings 34 and 35 of the sensing board assembly, which are disposed adjacent to the outlet port, as well as the upper and lower sides of the sensing board 32. The coolant flowing out into the battery module housing 10 may be discharged to the outside through the outlet port.

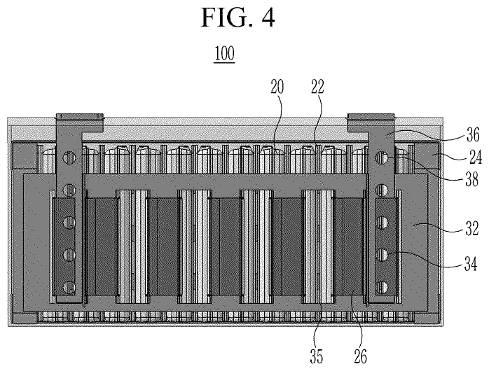

FIG. 4 is a front view showing that the sensing board and the bus bar are connected to the electrode lead in the battery module cooling structure according to an embodiment of the disclosure.

Referring to FIG. 4, the bus bar 36 may be overlapped and coupled with the sensing board 32, and the first flow opening 34, which simultaneously passes through the bus bar 36 and the sensing board 32, may be formed in the portion where the bus bar 36 and the sensing board 32 are overlapped and coupled with each other. The first flow opening 34 may include the plurality of circular openings formed in the length direction of the bus bar 36. In addition, the first flow opening 34 may be further formed in a portion where the bus bar 36 and the sensing board 32 are neither overlapped nor coupled with each other.

The electrode lead 26 may be in electrical contact with the bus bar 36 by passing through the second flow opening 35 in the portion where the bus bar 36 and the sensing board 32 are overlapped and coupled with each other and being folded toward the bus bar 36. In addition, the electrode lead 26 may have an opening that aligns with the first flow opening 34 in this portion.

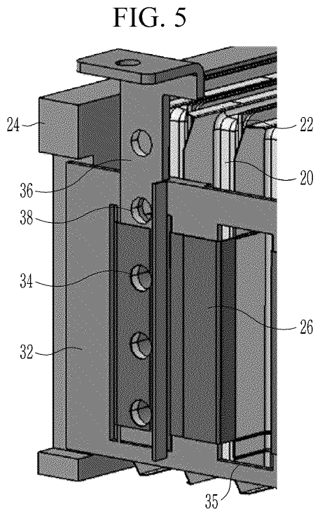

FIG. 5 is a partial perspective view showing that the sensing board and the bus bar are connected to the electrode lead in the battery module cooling structure according to an embodiment of the disclosure.

Referring to FIG. 5, the sensing board assembly may be disposed to extend in the stacking direction of the plurality of battery cells 20, and the end of the sensing board 32 may be fastened to the end of the end plate 24. The bus bar 36 may be connected to the sensing board 32, and the electrode lead 26 may pass through the second flow opening 35 formed in the sensing board 32 and be folded to be in electrical contact with the bus bar 36.

The first flow opening 34 may be formed in the bus bar 36, and an opening forming the same opening as the first flow opening 34 may be formed in the electrode lead 26. In addition, the first flow opening 34 and the second flow opening 35 may be overlap in the portion where the bus bar 36 is fastened.

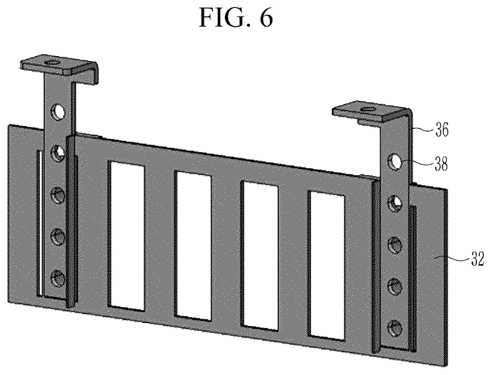

FIG. 6 is a perspective view showing that the sensing board and the bus bar are connected to each other in the battery module cooling structure according to an embodiment of the disclosure.

The bus bar 36 may be disposed to extend in a direction perpendicular to the length direction of the sensing board 32, and may be coupled to the sensing board 32 to protrude further than an upper part of the sensing board 32. The first flow opening 34 may also be formed in a portion of the bus bar 36, which protrudes further than the upper part of the sensing board 32. An upper end of the bus bar 36 may be curved toward the outside of the battery module in the perpendicular direction.

The plurality of second flow openings 35 may each have a square shape and be formed in the length direction of the sensing board 32. The first flow opening 34 may be formed in the portion where the sensing board 32 and the bus bar 36 are overlapped with each other, and where the bus bar 36 protrudes further than the upper part of the sensing board 32. The first flow opening 34 and the second flow opening 35 may overlap in the portion where the bus bar 36 is overlapped with the sensing board 32.

This structure may enable the coolant flowing into the battery module housing 10 to flow to the plurality of battery cells 20 through the first and second flow openings 34 and 35 and the upper and lower spaces of the sensing board 32. The coolant passing through the plurality of battery cells 20 may then flow out through the sensing board assembly disposed on the other side, which has the same structure as described above. As a result, the maximum coolant flow path may be ensured, thereby achieving the maximum cooling performance of the battery cell 20.

As set forth above, according to an embodiment of the disclosure, the flow opening, through which the coolant flows, may be formed in the sensing board or the bus bar in the immersion cooling battery module to thus allow the coolant to flow in, flow, and flow out through the optimal path between the battery cells, thereby maximizing the cooling performance efficiency.

In addition, the flow opening may be formed in the sensing board to thus increase the flow rate into the battery cell, thereby improving the cooling performance and reducing the temperature difference between the battery cells.

In addition, the flow opening may be formed in the bus bar to thus expand the surface area of the bus bar and increase the cooling effect in response to the large amount of heat occurring in the bus bar.

Although the embodiments of the disclosure have been described hereinabove, the scope of the disclosure is not limited thereto, and all equivalent modifications easily modified by those skilled in the art to which the disclosure pertains are intended to fall within the scope and spirit of the disclosure.

What is claimed is:

1. A structure for cooling a battery module, the structure comprising:
a battery module housing storing the battery module, wherein the battery module is configured by assembling a plurality of battery cells; and
a sensing board assembly fastened to an end plate disposed on an outermost side of the battery module, the sensing board assembly extending in a stacking direction of the plurality of battery cells and having a flow opening to allow coolant to flow between the plurality of battery cells.

2. The structure of claim 1, wherein the sensing board assembly comprises:
a sensing board electrically connected to an electrode lead disposed on the battery cell and configured to detect a state of the battery cell, and
a bus bar electrically connected to the sensing board and configured to connect a voltage line between the battery cells in the battery module or between the battery modules.

3. The structure of claim 2, wherein the bus bar comprises additional surface area with flow openings.

4. The structure of claim 2, wherein the bus bar is overlapped and coupled with the sensing board, and the flow opening comprises:
a first flow opening formed in a portion where the bus bar and the sensing board are overlapped and coupled with each other, simultaneously passing through the bus bar and the sensing board, and
a second flow opening formed in a portion where the bus bar and the sensing board are neither overlapped nor coupled with each other, passing through the sensing board.

5. The structure of claim 4, wherein the first flow opening comprises a plurality of circular openings formed in a length direction of the bus bar.

6. The structure of claim 5, wherein the first flow opening is further formed in the portion where the bus bar and the sensing board are neither overlapped nor coupled with each other.

7. The structure of claim 4, wherein the second flow opening comprises a plurality of square openings arranged in the stacking direction of the plurality of battery cells.

8. The structure of claim 4, wherein the plurality of square openings are elongated in the length direction.

9. The structure of claim 4, wherein the plurality of square openings correspond to channels between the plurality of battery cells.

10. The structure of claim 4, wherein the electrode lead is in electrical connection with the sensing board by passing through the second flow opening to be folded and overlapped with the sensing board.

11. The structure of claim 4, wherein the electrode lead is connected to the sensing board to be overlapped with the first flow opening, and has an opening overlapped with the first flow opening.

12. The structure of claim 1, wherein the sensing board assembly is installed on each of two ends of the battery module housing.

13. The structure of claim 1, wherein a plurality of pressure pads are respectively attached to outer surfaces of the battery cells.

14. The structure of claim 13, wherein each of the plurality of pressure pads is disposed between adjacent battery cells and is configured to absorb swelling of the battery cells.

15. The structure of claim 13, wherein each of the plurality of pressure pads is configured to fix the plurality of battery cells in position and relieve impact applied to the battery cells.

16. The structure of claim 1, wherein the battery module housing comprises an inflow port for the coolant on one side and an outlet port for the coolant on the opposite side, the inflow port and the outlet port communicating with the inside of the battery module housing.

17. The structure of claim 16, wherein the positions of the inflow port and the outlet port are asymmetric to ensure even coolant flow within the battery module housing.

18. The structure of claim 17, wherein the inflow port and the outlet port are positioned vertically or laterally relative to each other.

19. The structure of claim 1, wherein the sensing board assembly is fastened to an end of the end plate.

20. A vehicle comprising the structure of claim 1.
